(19) United States
(12) Patent Application Publication
(10) Pub. No.: US 2006/0287082 A1
(43) Pub. Date: Dec. 21, 2006

(54) Game system with enhanced control for moving displayed virtual objects

(76) Inventor: Fabrice Madigou, Andresy (FR)

Correspondence Address: Blakely, Sokoloff, Taylor & Zafman, 12400 Wilshire Boulevard, 7th Floor, Los Angeles, CA, 90025, US

(21) Appl. No.: 10/583,652

(22) PCT Filed: Dec. 18, 2003
(86) PCT No.: PCT/FR03/03791

§ 371 Date: Jun. 16, 2006

(30) Foreign Application Priority Data
Dec. 18, 2002 (FR) 02/16074

(51) Int. Cl. A63F 13/00

(52) U.S. Cl. 463/37

(57) ABSTRACT

An electronic game system comprises a central processing unit, a display device (D) and at least one displaceable input actuator (M) such as a gamepad.

It is remarkable in that it comprises means (E_{A}-E_{D}, R₁, R₂) of transmitting/receiving signals between a fixed part (D) of the system and the said actuator (M), processing means capable of deriving at least one item of actuator position and/or orientation information from the said signals, and control means that can apply the position and/or orientation information to the processing unit, to act on the displacement of virtual objects displayed on the display device. Application to all types of electronic games, with vertical or flat screen.

This invention relates in general to input devices for simulators and electronic games, known particularly under the term “gamepads”.

Gamepads known at the present time are provided with an electrical connecting cable leading to a game console input connector or to a computer, and the user needs to press on one or several buttons in order to move a character or a mobile object displayed on the screen in the required direction while executing the game.

This process requires a certain amount of learning by the user since displacement of the object is not intuitive. When a beginner (child or adult) is observed performing such manipulations, it can be seen that he is uncomfortable in making the actions of the finger(s) match the required displacement.

Specialised electronic game equipment is known capable of converting movements of portable equipment (virtual sword handle, headset) into electronic control actions. Documents U.S. Pat. No. 6,162,123 A, EP-1 249 260 A, US 2002/0175897 A and EP-1 060 772 A give examples of such equipment.

However, all these known approaches are relatively clumsy compared with dedicated games, typically “arcade” games for public locations, and they are complicated to use.

Furthermore, if it were required to use this equipment with several different types of games, dedicated actuators would have to be added and the necessary adaptations would have to be made.

This invention is designed to overcome these problems and to propose a standard, simple and economic input device for various types of electronic games, that can provoke displacements of an object or a mobile virtual character on the display screen in a particularly intuitive manner and is therefore easy to control, in addition to action controls such as displacement buttons usually provided on the input device.

Yet another purpose of the invention is to enable the use of directional displacement buttons that are conventional in themselves, but for which the action depends on the orientation of the gamepad with respect to the screen.

To achieve this, according to a first aspect, the invention proposes an electronic game system comprising a central processing unit, a display device and at least one universal displaceable input actuator that can be held in a player's hands and that can generate standard control information for a plurality of electronic game programs each of which can be executed by the processing unit, characterised in that it comprises means of transmitting/receiving signals between a fixed part of the system and the said actuator, processing means capable of determining path time data for transmitted signals to generate one or more items of actuator position and/or orientation information, and control means that can apply commands based on the position and/or orientation information to the processing unit, to act on the displacement of virtual objects displayed on the display device.

The position information may be absolute or relative.

Some preferred but non-limitative aspects of this system are given below:
the transmission/reception means provided on the fixed part of the system include transmitters or receivers provided close to the display device;
the system comprises at least one receiver on the fixed part and at least one transmitter on the actuator, the said transmitter also being capable of transmitting actuator identification information to the central unit through the said receiver;
the system also comprises a transmitter on the actuator capable of transmitting actuation information determined from an actuatable element provided on the actuator, through a receiver on the fixed part, to the central unit;
the system comprises a plurality of transmitters on the fixed part and a plurality of receivers on the actuator;
the processing means are capable of determining changes in the position of the actuator with respect to the fixed part, with five degrees of freedom;
the processing means are capable of determining changes in the position of the actuator with respect to the fixed part, with six degrees of freedom;
the actuator comprises three non-aligned transmitters or receivers.

According to a second aspect, the invention proposes a universal displaceable input actuator that can be held in a player's hands, to apply control signals to an electronic game system comprising a central processing unit and a display device, characterised in that it comprises means of transmitting signals by wireless transmission from at least two transmitters at a distance from each other on the actuator, the said transmitters transmitting distinct signals that can be used to determine the position and/or orientation of the actuator from at least two fixed receivers.

In one embodiment, the actuator comprises a displacement control part moving with respect to another part, the transmitters are fixed on the displacement control part, and at least one receiver is fixed on the said other part.

The invention also proposes a universal displaceable input actuator that can be held in a player's hands, to apply control signals to an electronic game system comprising a central processing unit and a display device, characterised in that it comprises means of reception of signals by wireless transmission at at least one receiver, the receiver being capable of receiving distinct signals transmitted by at least two fixed transmitters to enable determination of the actuator position and/or orientation.

In one embodiment, the actuator comprises a displacement control part that moves with respect to another part, in which the receiver or each receiver is fixed on the displacement control part, and in which at least one transmitter is fixed on the said other part.

Other aspects, purposes and advantages of this invention will become clearer after reading the following detailed description of preferred embodiments of the invention given as a non-limitative example and with reference to the appended drawings, wherein:

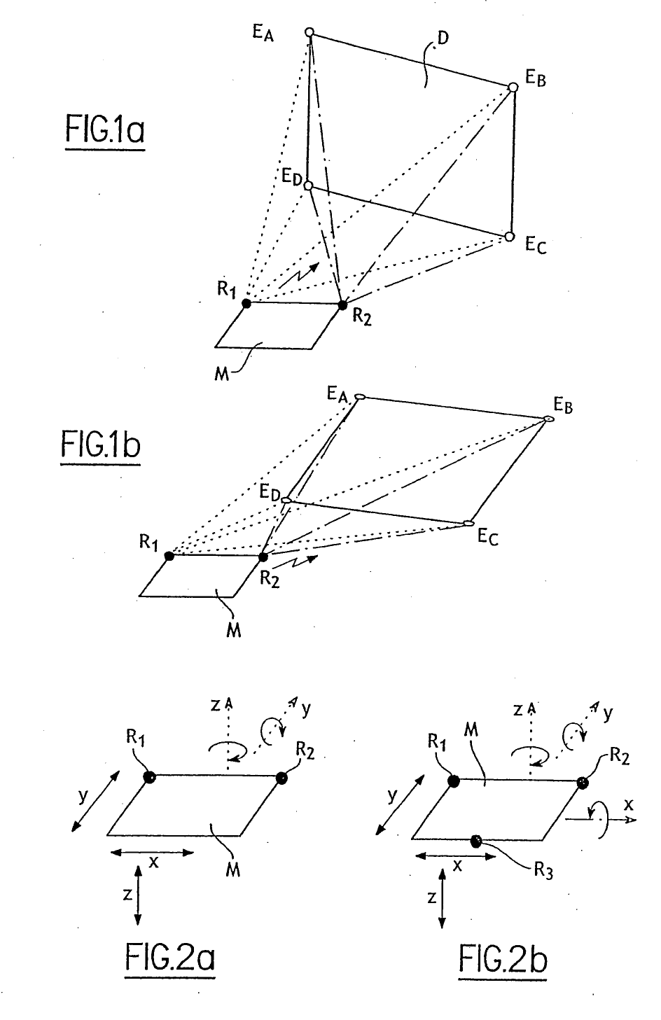

FIGS. 1a and 1b are perspective diagrams illustrating two example embodiments of the invention,

FIGS. 2a and 2b are perspective diagrams illustrating two embodiments of a gamepad according to the invention,

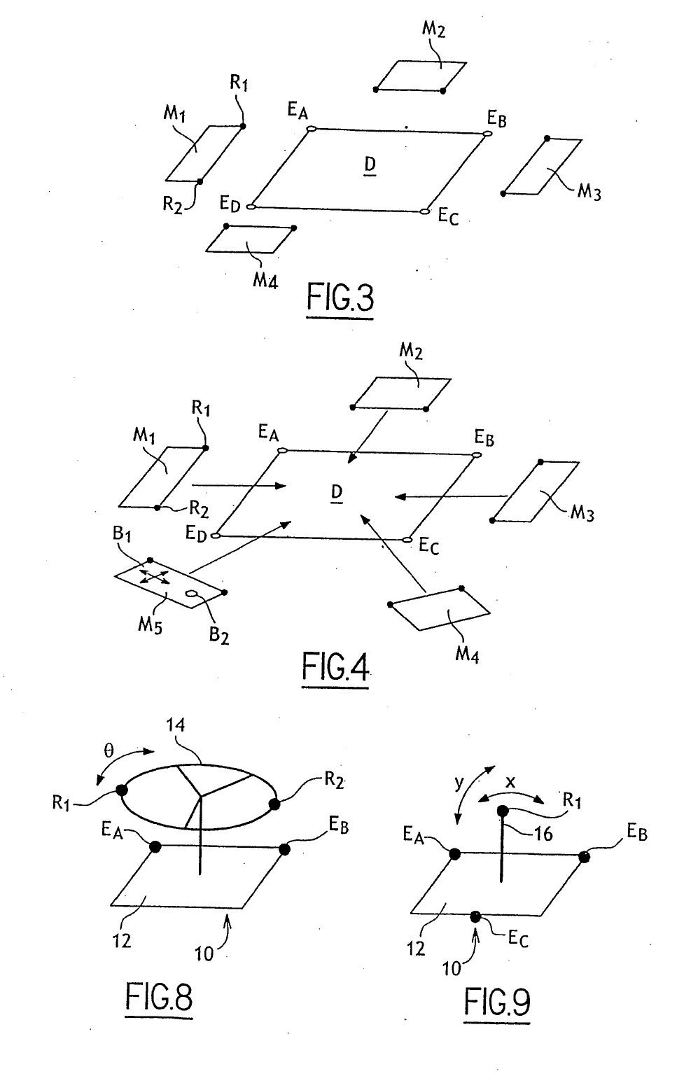

FIG. 3 is a perspective diagrammatic overview of an electronic game platform and a set of gamepads,

FIG. 4 is a view similar to FIG. 3 with an additional gamepad, the gamepads being provided with directional control buttons,

FIG. 5 is a functional diagram of an electronic part of a gamepad according to the invention,

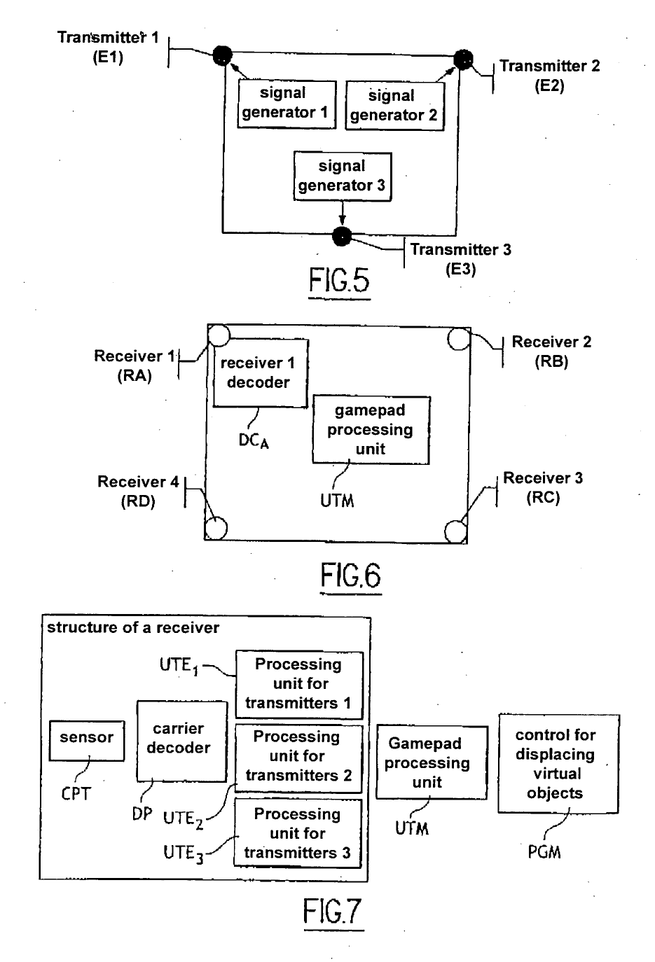

FIG. 6 is a functional diagram of a part of the electronics of a game platform capable of cooperating with such a gamepad,

FIG. 7 is a more detailed functional diagram of this part of the electronics,

FIG. 8 diagrammatically illustrates application of this invention to an input device of the virtual driver's steering wheel type, and

FIG. 9 diagrammatically illustrates the application of the invention to a joystick type input device.

Firstly, note that the invention is particularly applicable to an electronic game platform like that described in document WO 02 20110 A issued by the applicant, but it is also equally applicable to electronic game systems with a vertical screen.

First with reference to FIG. 1A, the Figure diagrammatically shows the display screen part D of an electronic game system such as action games, parlour games, etc., the screen in this case being approximately vertical and facing a player.

This system comprises four signal transmitters E_{A} to E_{D} (radio frequency, infrared, ultrasonic wave signals, etc.) capable of propagating at a determined speed as far as a gamepad M, preferably around the screen D. In fact, these transmitters are arranged in the region of the four corners of the screen D, but many other arrangements are possible.

In this case, the gamepad M is provided with two receivers R₁ and R₂ capable of receiving signals transmitted by the corresponding four transmitters, these receivers in this case being located in the region on the opposite sides of the gamepad, symmetrically about an axial plane of the gamepad.

FIG. 1b illustrates the fact that the same system may be implemented with a display screen D, for example placed horizontally, as described in document WO 02 20110 A mentioned above.

Transmitters E_{A} to E_{D} output four distinct signals, that are listened to by receivers R₁ and R₂.

It is known that the time that elapses between when a given signal is transmitted by one of the transmitters and when the same signal is received by one of the receivers is proportional to the distance between the transmitter and the receiver being considered. Therefore, the system is capable of determining the above-mentioned distance by processing the signal based on times of reception of the same signal transmitted by the different receivers. And the use of several transmitters and several receivers, and of a plurality of associated measured distances, provides a means of deducing the position and/or orientation of the gamepad M taken as a whole with respect to transmitters E_{A} to E_{D} and therefore with respect to the screen. In order to avoid making the description unnecessarily complicated, we will not describe the different calculations used to obtain the position and/or orientation data for the gamepad; these calculations make use of conventional geometry and those skilled in the art are quite familiar with them.

If this type of measurement is made at a high frequency, for example 10 to 100 times per second, the system determines the dynamic variation of distances and uses them to deduce the movements of the gamepad M made by the user with respect to the screen D.

In a first embodiment, the position and/or orientation calculations of the gamepad M are done in a processing unit located in the gamepad itself.

In a second embodiment, the gamepad simply transmits time data representing instants at which signals transmitted by transmitters E_{A} to E_{D} are received by receivers R₁ and R₂ to the game system, either through a wire link or a wireless link.

Note that the use of two receivers R₁ and R₂ located on opposite sides and the use of at least three transmitters is sufficient to calculate the position and the orientation of the gamepad with five degrees of freedom, as illustrated in FIG. 2a in the drawings, namely a translation along three orthogonal axes x, y and z (where z is the vertical, x is the lateral direction, and the y direction is forward/backward with respect to the user), and rotation about the y and z axes, and the only unknown that cannot be determined is rotation about the x axis parallel to the straight line joining the two receivers.

According to one variant, with reference to FIG. 2b, translations/rotations in six possible degrees of freedom can be determined by providing a third receiver R₃ on the gamepad M, provided that it is offset from the receivers R₁ and R₂ along the y axis and/or along the z axis. In fact, while receivers R₁ and R₂ are located at the left or right side at the “front” face of the gamepad (the face furthest from the user), the receiver R₃ is at the middle of its opposite or back face.

Advantageously, the gamepad M also comprises one or several buttons (see B₁ and B₂ on the gamepad M₅ in FIG. 4), namely traditional buttons (directional buttons, joystick, action keys, etc.) and/or buttons that will have an influence on the process for determination of the initial position and the orientation of the gamepad M.

In particular, a button can be provided to activate/deactivate determination of the position of the gamepad according to the process described above.

As mentioned above, the gamepad M uses a preferably wireless connection to supply information about its position with respect to the transmitters and therefore to the screen with reference to all or some of the six degrees of freedom, and actions or information necessary for operation of the system, to the electronic game system (platform, dedicated console or personal computer).

Advantageously, and now with reference to FIG. 3, the system enables the use of several gamepads, in this case four gamepads M₁ to M₄.

In this case, the communication of each gamepad with the system is differentiated (this is natural with a wire link, and for example it may be made simply by adding an identifier in transmitted messages). Thus, position data or time data transmitted by each gamepad to the central system are assigned to the corresponding gamepads.

There can be a very wide variety of actions to displace a virtual mobile object displayed on the screen D as a function of translation and/or rotation movements of the gamepad.

The following assignments may thus be made:

| Gamepad movement | Object movement |
|---|---|
| Rotation/z | direct left right |
| Translation/y | accelerate/decelerate |
| Rotation/x | raise/lower |
| Translation/x | step on the side |
| Etc. | |

As already mentioned, it may be desirable to keep a conventional control by directional buttons (B₁ in FIG. 4) on the gamepad in cooperation with a screen arranged horizontally. In this case, the gamepad may be positioned along a predefined direction. Then, by action on a determined button, this horizontal position is memorised so that actions on directional buttons act along directions that take account of the memorised position of the gamepad.

For example, in the case in FIG. 4, it is assumed that a fifth player with a gamepad M₅ joins a group of four players using gamepads M₁ to M₄ respectively, on the same side of the electronic platform as the player with gamepad M₄.

Determination of the position of the gamepad M₅ with respect to the system makes it possible to organise the system such that when the fifth player uses the front/back/left/right directional buttons on his gamepad, the corresponding movements of the mobile object on screen D are made along the directions as observed from the observation point of the said player.

According to one variant embodiment, signal transmitters can be located on the gamepads and the corresponding receivers can be fixed, preferably close to the screen. Thus, as illustrated in FIG. 5, in this case the gamepad M is provided with three transmitters E₁ to E₃ connected to three signal generators GS₁ to GS₃, respectively.

Each gamepad sends different signals, so as to differentiate signals transmitted by several gamepads.

FIG. 6 illustrates the region of the display screen D surrounded by four receivers R_{A} to R_{D} located in the region of its four corners. A decoder circuit is associated with each receiver, but only circuit DC_{A} associated with the receiver R_{A} is shown in the Figure. Each decoder circuit is connected to a gamepad processing unit UTM that receives signals from the decoder circuits and generates position/orientation data for the corresponding gamepads, used as input data in the associated game program.

Starting from time components contained in the received signals, the processing unit UTM dynamically calculates the distance between each transmitter and each receiver and uses these distances to calculate movements made by the user to generate input data to the game application executed by the system.

With this approach, transmitters located on gamepads are also advantageously used to transmit other information such as button manipulation events, joystick events, etc., also addressed to the game application.

As we have already said, the distance measurement may be made by different transmission techniques, and particularly using infrared, ultrasound, radio frequency signals, etc.

Preferably, if the transmitters are located on the gamepads M, each transmitter sends a pulse stream on a different frequency carrier, this pulse stream forming a specific code uniquely identifying the gamepad.

Thus, the carrier identifies the transmitter considered among the plurality of transmitters, while the pulses identify the gamepad.

At the receiver end, now with reference to FIG. 7, each receiver comprises a sensor CPT chosen as a function of the technology considered, and a carrier decoder DP that separates the different carriers originating from each of the two or more transmitters.

There are also another three transmitter processing units denoted UTE₁, UTE₂ and UTE₃, each of which is capable of calculating the distance between the associated transmitter and the receiver considered.

FIG. 8 shows a steering wheel type input device 10 for virtual racing, with a base 12 and a turning steering wheel 14. The steering wheel is provided with two receivers R1 and R2 and the base is provided with two transmitters Ea and Eb. A periodic calculation based on the travel time of signals between transmitters and receivers, is used to determine the variation of the angle of rotation of the steering wheel 14 with respect to the base 12, using mathematical calculations known to those skilled in the art. The electrical signals representative of this variation are applied to game or control simulator programs for controlling the virtual vehicle.

FIG. 9 illustrates another input device 10, with a base 12 and a joystick 16 capable of pivoting about a hinge located at its base, along an x direction and along a y direction. The joystick is provided with a receiver R1 at a distance from its articulation point, while the base supports three transmitters EA, EB and EC. In this case, the variation of signal paths with time between the three transmitters and the receiver provides a means of determining the position of the joystick and how it is changing.

Obviously, the transmitters and the receivers in these embodiments could be reversed.

Many variants and modifications may be made to the invention.

However, in the case of a dedicated games console for which the display screen is an ordinary television set, the fixed transmitters or receivers and the associated processing electronics are preferably located on the console itself, or in the form of a fixed element distinct from the said console but connected to it.

1. Electronic game system comprising a central processing unit, a display device (D) and at least one universal displaceable input actuator (M; 14; 16) that can be held in the player's hands and can generate standard control information for several electronic game programs that can all be executed by the processing unit, characterised in that it comprises means (Eₓ, Rᵢ, Eᵢ, Rₓ) of transmitting/receiving signals between a fixed part (D; 12) of the system and the said actuator (M), processing means capable of determining path time data for transmitted signals to generate one or more items of actuator position and/or orientation information, and control means that can apply controls based on the position and/or orientation information, to the processing unit to act on the displacement of virtual objects displayed on the display device.

2. System according to claim 1, characterised in that transmission/reception means provided on the fixed part of the system include transmitters or receivers provided close to the display device.

3. Game system according to either claim 1 or 2, characterised in that it comprises at least one receiver on the fixed part and at least one transmitter on the actuator, and in that the said transmitter (Eᵢ) is capable of transmitting actuator identification information to the central unit through the said receiver.

4. Game system according to claim 3, characterised in that it also comprises a transmitter (Eᵢ) on the actuator capable of transmitting actuation information determined from an actuatable element provided on the actuator, through a receiver on the fixed part, to the central unit.

5. Game system according to either claim 1 or 2, characterised in that it comprises a plurality of transmitters (Eₓ) on the fixed part and a plurality of receivers (Rᵢ) on the actuator.

6. System according to one of claims 1 to 5, characterised in that the processing means are capable of determining changes in the position of the actuator with five degrees of freedom.

7. System according to one of claims 1 to 5, characterised in that the processing means are capable of determining changes in the position of the actuator with six degrees of freedom.

8. System according to claim 8, characterised in that the actuator comprises three non-aligned transmitters (E₁-E₃) or receivers.

9. Universal displaceable input actuator (M; 14; 16) that can be held in a player's hands, to apply control signals to an electronic game system comprising a central processing unit and a display device, characterised in that it comprises means of transmitting signals by wireless transmission from at least two transmitters (E₁-E₃) at a distance from each other on the actuator, the said transmitters transmitting distinct signals that can be used to determine the position and/or orientation of the actuator from at least two fixed receivers (Rₓ).

10. Actuator according to claim 9, characterised in that at least one transmitter (E₁-E₃) is capable of transmitting actuator identification information.

11. Actuator according to either claim 9 or 10, characterised in that at least one transmitter (E₁-E₃) is also capable of transmitting actuation information determined from an actuatable element provided on the actuator.

12. Actuator according to one of claims 9 to 11, characterised in that it comprises a displacement control part that moves with respect to another part, in that the transmitters are fixed on the displacement control part, and in that at least one receiver is fixed on the said other part.

13. Universal displaceable input actuator (M; 14; 16) that can be held in a player's hands, to apply control signals to an electronic game system comprising a central processing unit and a display device, characterised in that it comprises means of reception of signals sent by wireless transmission at at least one receiver (Rᵢ), the receiver being designed to receive distinct signals transmitted by at least two fixed transmitters (Eₓ) to determine the position and/or orientation of the actuator.

14. Actuator according to claim 13, characterised in that it comprises a displacement control part free to move with respect to another part, and in that the receiver or each receiver is fixed on the displacement control part, and in that at least one transmitter is fixed on the said other part.
